(19) United States
(12) Patent Application Publication
(10) Pub. No.: US 2021/0087088 A1
(43) Pub. Date: Mar. 25, 2021

(54) SEPTIC TANK OR AEROBIC TANK LEVEL CONTROL SYSTEM

(71) Applicants: Tommy Gig DREWERY, Longview, TX (US); Trina Vern DREWERY, Longview, TX (US)

(72) Inventors: Tommy Gig DREWERY, Longview, TX (US); Trina Vern DREWERY, Longview, TX (US)

(21) Appl. No.: 17/014,748

(22) Filed: Sep. 8, 2020

Related U.S. Application Data
(60) Provisional application No. 62/871,428, filed on Jul. 8, 2019.

(51) Int. Cl. C02F 3/28; C02F 3/00; C02F 3/12

(52) U.S. Cl. CPC C02F 3/288; C02F 3/006; C02F 2209/42; C02F 2209/40; C02F 3/1236

(57) ABSTRACT

A septic tank or aerobic treatment tank level control system has a tank adapted to be connected to a sewage outlet line of a building, a transfer line connected to an outlet of the tank and adapted to extend to a drainfield, a drainfield distribution unit connected to the transfer line, a pump positioned in the tank, a discharge line connected to the pump and connected to the outlet of the tank, and a level switch operatively connected to the pump. The discharge line is adapted to pass the liquid under pressure from the pump through the outlet of the tank and into the drainfield distribution unit. The level switch activates the pump when the liquid in the tank reaches a first level and deactivates the pump when the level of liquid in the tank reaches a second level. The first level is higher than the second level.

### CROSS-REFERENCE TO RELATED APPLICATIONS

The present application claims priority pursuant to Subsection 12004(a) of the CARES Act and 37 C.F.R. § 1.83 priority to prior-filed U.S. Patent Provisional Application Ser. No. 62/871,428, filed on Jul. 8, 2019 and entitled “Septic Tank Level Control Device”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to septic tanks and aerobic treatment tanks. More particularly, the present invention relates to the discharge of liquids from the tank to a gravity-flow drainfield. More particularly, the present invention relates to systems and methods for controlling the level of the liquid within the septic tank or aerobic treatment tank.

### 2. Description of Related Art Including Information Disclosed Under 37 CFR 1.97 and 37 CFR 1.98

Conventional septic tanks and gravity-flow drainfields have been used to treat and dispose of domestic wastewater from homes and small commercials establishments successfully for years. It is still the preferred method of choice even though it has several problems and shortcomings.

Conventional septic tanks use anaerobic bacteria to treat the wastewater both in the septic tank and in the drainfield. The majority of the treatment is accomplished in the drainfield. Anaerobic bacteria attach themselves to the soil interface on the bottom and side walls of the drainfield. This is where the final treatment of the wastewater effluent occurs before entering the environment or groundwater. As the anaerobic bacteria attach themselves to the soil interface and start treating the wastewater, they form or grow a biomat or scum. This biomat also starts to plug the soil interface. After a number of years, enough of the soil is plugged such that wastewater starts to back up into the septic tank. This process occurs over several years. During this period or process, homeowners are faced with drainage issues such as an inability to flush a commode, slow drains, gurgling sounds, along with tubs and showers that do not drain. This is a big problem for homeowners. A homeowner can spend hundreds or thousands of dollars having their septic tank pumped out in an attempt to alleviate the problem. Since it is the ground water and drainfield that is clogged, the problem does not lie in the septic tank but rather in the drainfield. As such, any attempt to pump out and remove material or liquid from the septic tank will have minimal benefit to the long-term operation of the septic tank.

FIG. 1 shows a gravity-flow septic tank and gravity-flow drainfield system 10 of the prior art. As can be seen, there is a building 12 having a toilet 14 in an interior thereof. A sewage outlet line 16 is connected to the drain of the toilet (or any other drain within the building 12). The sewage will flow into the septic tank 18. The septic tank 18 can be of a single compartment or can include multiple compartments, such as first compartment 20 and second compartment 22. The first compartment 20 receives the sewage from the sewage outlet line. When the sewage in the first compartment 20 reaches level 24, it will flow through pipe 26 to the second compartment 22. The second compartment 22, along with any subsequent compartments, will act to further clarify the liquid in the septic tank. The pipe 26 has an inlet that extends downwardly in the first compartment 20. As such, the inlet to the pipe 26 will open into a central zone of the sewage within the first compartment 20. This is in an area between scum (at the top of the liquid 30) and sludge (at the bottom 28 of the first compartment 20). The somewhat clarified liquid 30 will then be received in the second compartment 22. Second compartment 22 will serve to further clean materials from the liquid 30. Ultimately, when the liquid 30 reaches level 32, it will flow through outlet (or outlet tee) 34 and into the transfer line 36. The transfer line 36 is received below grade 38 of drainfield 40. It can be seen that the transfer line 36 is connected to a drainfield distribution unit 41. The drainfield distribution unit 41 has a plurality of openings 42 formed therein. These openings will allow the transfer line 36 to discharge the liquid 30 (as passed through outlet 34) to be discharged into the drainfield 40.

Since the transfer line 36 discharges the liquid by gravity into the drainfield 40, the wastewater effluent is absorbed or percolated into the soil of the drainfield 40. The effluent will receive treatment at the soil interface as the biomat forms. Ultimately, the effluent wastewater will percolate to groundwater.

So as to accommodate those problems associated with the clogging of the drainfield 40, the prior art has envisioned the installation of a pump tank 44 (illustrated by the system 46 in FIG. 2). In particular, the system 46 includes a building 48 having a toilet 50 therein. The sewage outlet line 52 will extend to the septic tank 54. Septic tank 54 can be a single compartment or a multiple compartment septic tank. The illustration of FIG. 2 shows the septic tank 54 as being a dual compartment septic tank (similar to that shown in FIG. 1). Ultimately, the effluent wastewater from the septic tank 54 will flow through outlet pipe 56 and into pump tank 44.

Pump tank 44 has a pump 58 at the bottom thereof. As such, the pump 58 will take the effluent wastewater 60 within the interior of pump tank 44 and pass the liquid along line 62 to the drainfield pipe 64. A check valve 66 can be included along the discharge line 62 so as to prevent any backflow of liquid into the pump 58. A level switch 67 is cooperative at the pump 58 and floats with the level of the water 69 in the pump tank 44. As such, when the level 69 reaches a desired level, the float switch 67 will move so as to activate the pump 58 so as to deliver the wastewater effluent, under pressure, into the drainfield line 64.

In the system 46, wastewater flows from the building 48 and gravity flows through the septic tank 54 and into the pump tank 44. The pump 58 works with a level control switch so as to discharge the effluent into the drainfield 68. As the effluent gravity flows down the drainfield 68, it will absorb or percolate into the soil. The pump tanks 44 are used with the gravity-flow drainfields when the drainfield is at a higher elevation than the septic tank 54. Virtually all of the septic tanks and drainfields are installed in the manner described in FIG. 1 (without a pump tank).

One of the benefits of having the pump tank 44 with a gravity-flow septic tank 54 and a drainfield 68 is that the level in the septic tank 54 is always maintained at the normal operating level even during the last several years of the life of the drainfield. This system eliminates household issues such as the inability to flush the commode, slow drains.

Of course, one of the major problems associated with the system 46 of FIG. 2 is the installation of the pump tank 44. These pump tanks are quite expensive. Although they alleviate many of the problems associated with the ability to control the level of effluent in the septic tank 54, they require extra excavations in the landscape and require installation procedures. These installation procedures can be quite extensive. Ultimately, the landscape may be damaged or destroyed by the installation of such a pump tank 44. Under certain circumstances, the pump 58 may pump too much of the effluent outwardly of the pump tank 44 so as to virtually flood the drainfield.

FIG. 3 shows the system 10 of FIG. 1 under those circumstances in which the drainfield 40 is failing. After several years of use, a biomat 41 (scum) will build up on the bottom of the drainfield 40. As such, percolation is prevented. The soil at the drainfield 40 becomes plugged. As a result, during wet weather conditions or high usage, periodic high level conditions develop in the drainfield. It is this condition that causes the effluent to back up in the septic tank 18 and cause a high level 24 and 32 within the septic tank 18. As a result, drainage issues will occur and, as such, one will not be able to flush the toilet 14 located within the building 12. Additionally, it is difficult for other liquids to drain through other drains located within the building 12.

In the past, various patents and patent application publications have issued with respect to septic tank pumps. In particular, U.S. Patent Application Publication No. 2010/0224577, published on Sep. 9, 2010 to E. S. Ball, describes the treatment of wastewater by receiving wastewater having a reduced concentration of heavy solids into a secondary container space and allowing the heavy solids to distribute into a lower horizontal sludge layer, and upper horizontal scum layer, and a relatively clear horizontal layer of liquid therebetween. The liquid flows from the relatively clear layer to at least one filter element enclosed in the housing. The top of the filter element is submerged below the wastewater level of the secondary containment space. The filtered effluent thereafter flows out of the housing.

U.S. Pat. No. 5,492,635, issued on Feb. 20, 1996 to E. S. Ball, shows a septic tank effluent filtering method. A mesh screen filter is immersed in wastewater having a concentration of waste solids which have been allowed to distribute into a scum layer and a sludge layer with a horizontal layer of liquid therebetween. The filter is surrounded with the housing. The interior surface of the housing is exposed to the horizontal layer of liquid through a plurality of apertures in the housing. Liquid from the horizontal layer flows through the apertures into the housing and thereafter the liquid flows from one side of the filter to an opposite side thereof through a mesh screen filtering surface area greater than the interior surface area of the housing. Thereafter, the liquid flows through a liquid effluent outlet of the container.

U.S. Pat. No. 5,480,561, issued on Jan. 2, 1996 to Ball et al., describes a method and apparatus for treating wastewater in a recirculating filter. Solids are removed from the wastewater by gravitational separation and the wastewater is flowed to a tank. At least a portion of the wastewater is flowed from the tank to a filter. The filter is comprised of filter media. The wastewater flows through the filter media in order to produce a filtrate. The amount of wastewater in the tank is sensed. When the amount of wastewater sensed is at least a predetermined amount, a fraction of the filtrate is returned to the tank. When the amount of wastewater is less than the predetermined amount, more than the fraction of filtrate is returned to the tank by decreasing resistance to flow of the filtrate to the tank. The apparatus includes a tank and a filter connected by a conduit for conducting liquid from the tank to the filter. A conduit assembly connects a filter outlet and a discharge conduit for conducting liquid from the filter to the discharge conduit.

U.S. Pat. No. 6,372,137, issued on Apr. 16, 2002 to T. R. Bounds, shows a wastewater treatment system for maximizing effluent quality. The wastewater treatment system includes a septic tank which flows substantially all of the liquid effluent through an aerobic filter having a filter medium to produce a nitrified filtrate of reduced biological oxygen demand and total suspended solids. The majority of the filtrate is returned to the septic tank for denitrification followed by further recirculation through the anaerobic filter. All permanent discharge of effluent from the system is in the form of filtrate from an aerobic filter. Permanent discharge of effluent directly from the septic tank is prevented.

U.S. Pat. No. 4,793,386, issued on Dec. 27, 1988 to E. H. Sloan, discloses a portable submersible pump to mix and fluidized waste material in a septic tank. It then pumps it into a truck-mounted holding tank to recirculate in the holding tank during transport. It also discharges at a disposal site. The apparatus has a truck-mounted holding tank having tank inlet and outlet ports, a portable hydraulically driven submersible pump detachably mounted on the truck, and a truck-mounted motor-driven hydraulic pump for operating the portable pump. A waste hose is wound on a truck-mounted reel. In operation, the portable pump is disposed along side or in the septic tank and pumps a stream of pressurized fluid from the septic tank.

U.S. Pat. No. 5,985,139, issued on Nov. 16, 1999 to K. E. Zoeller, describes a septic tank pump and filter system for filtering effluent in a septic tank. The system includes a filter housing with sides. The filtering system is secured within a filter housing. A vertical tubular element is secured to the outside of the filter housing in communication with unfiltered effluent from within the septic system and with an opening in the bottom or side of the filter housing. A pump serves to pump filtered effluent through the filtering system. A check valve is secured within the bottom of the filter housing.

The present inventors developed an apparatus for converting a septic tank into an aerobic treatment system. This was described in U.S. patent application Ser. No. 16/551,005, filed on Aug. 26, 2019. This apparatus converts the septic tank into an aerobic treatment system by having a clarifier with a collapsible wall which allows the clarifier to fold in order to pass into the opening of the septic tank and to unfold upon entry into the septic tank. An aerator having a size suitable for passing through the opening in the septic tank will be positioned between the wall of the clarifier and the wall of the septic tank. An air pump is connected to the aerator so as to pass air to the aerator. The clarifier has an opening at a bottom thereof having a diameter no greater than a diameter of the top of the clarifier. The effluent outlet pipe is received in an aperture formed in the wall of the clarifier.

It is an object of the present invention to provide a septic tank or aerobic treatment tank level control system that delays the plugging of the soil interface of the drainfield.

It is another object of the present invention to provide a septic tank or aerobic treatment tank level control system that avoids backup in the septic tank or aerobic treatment tank.

It is still another object of the present invention to provide a septic tank or aerobic treatment tank level control device that does away with drainage issues for buildings.

It is another object of the present invention to provide a septic tank or aerobic treatment tank level control device that avoids unnecessary pumping and removal of liquid from septic tank or aerobic treatment tank.

It is another object of the present invention to provide a septic tank or aerobic treatment tank level control system that effectively and efficiently controls the level of water in septic tank or aerobic treatment tank during the life of the drainfield.

It is another object of the present invention to provide a septic tank or aerobic treatment tank level control system that avoids unnecessary excavations and the installation of additional tanks.

It is another object of the present invention to provide a septic tank or aerobic treatment tank level control system that avoids damage to the landscape around the wastewater treatment system.

It is another object of the present invention to provide a septic tank or aerobic treatment tank level control device that maintains a constant normal level of liquid in the septic tank or aerobic treatment tank.

It is further object of the present invention to provide a septic tank or aerobic treatment tank level control system that reduces the cost of equipment and installation.

It is another object of the present invention to provide a septic tank or aerobic treatment tank level control system that avoids the early installation of new drainfields.

It is still a further object of the present invention to provide septic tank or aerobic treatment tank level control system that prevents backflow into the septic tank or aerobic treatment tank.

It is still a further object of the present invention to provide a septic tank or aerobic treatment tank level control system that can be used with aerobic treatment and anaerobic treatment.

These and other objects and advantages of the present invention will become apparent from a reading of the attached specification and appended claims.

### BRIEF SUMMARY OF THE INVENTION

The present invention is a septic tank or aerobic treatment tank level control system. This septic tank or aerobic treatment tank level control system includes a tank adapted to be connected to a sewage outlet of a building, a transfer line connected to an outlet of the tank, a drainfield distribution unit connected to the transfer line and adapted to discharging liquid into the drainfield, a pump positioned in the tank, a discharge line connected to the pump and connected to the outlet of the tank, and a level switch operatively connected to the pump. The tank has an interior volume adapted to receive sewage from the sewage outlet line. The transfer line is adapted to extend to the drainfield. The drainfield distribution unit can be either a multi-orifice pipe or a leaching chamber. The multi-orifice pipe would have a plurality of openings adapted to discharge liquid into the drainfield. The transfer line is adapted to pass the liquid under pressure from the pump through the outlet of the tank and into the drainfield distribution unit. The level switch activates the pump when the liquid in the tank reaches a first level and deactivates the pump when the level of liquid in the tank reaches a second level. The first level will be higher than the second level.

In the preferred embodiment of the present invention, the tank is a septic tank or aerobic treatment tank. This septic tank can be used for anaerobic treatment. However, with modifications as described hereinabove, the septic tank can be used for aerobic treatment. The tank will have first compartment and a second compartment. The second compartment receives the liquid from the first compartment when a level of the sewage in the first compartment reaches a preset elevation. The first compartment is connected by a pipe to the second compartment. The pump is positioned in the second compartment. The discharge line extends to the pump within the second compartment. The second compartment also has access riser and the lid of the top thereof. The access and lid allow access to an interior of the second compartment of the septic tank. A bracket is affixed to at least one of the access riser and the lid. The discharge line is received by the bracket.

A flow orifice is affixed to or positioned within the discharge line. The flow orifice is adapted to restrict a flow rate of the liquid to the drainfield distribution unit. The discharge line extends upwardly from the pump so as to have a portion adjacent the top of the tank. The discharge line extends downwardly from this portion to the outlet of the tank. The discharge line has a check valve therein. The check valve prevents a flow of the liquid through the discharge line to the pump.

The level switch is, in the preferred embodiment, a float switch. However, a wide variety of other devices can be used as a level switch, such as level sensors, timers, gauges, and similar devices. When a float switch is used, the float switch will have a portion adapted to float on the liquid in the tank. The float switch is adapted to move between the first level and the second level of the liquid in the tank. The outlet of the tank is positioned a distance above the bottom of the tank and an opposite side of the tank from the inlet of the tank. The outlet of the tank has a vertical distance between the bottom of the an interior diameter of the outlet and a top of the interior diameter of the outlet. The first level is along the vertical distance above the bottom of the inner diameter of the outlet. The second level is at the bottom of the inner diameter of the outlet.

The pump has an inlet positioned in the tank. The pump has a filter over the inlet of the pump. The filter is adapted to prevent particles above a desired size from entering the pump inlet. The pump and the filter can be received within the interior of a vault. The vault is positioned in the tank and supports the pump a desired distance above a bottom of the tank. The vault has at least one opening whereby the liquid in the tank flows therethrough into the filter to the inlet of the pump.

The present invention can also include a drainfield in which the drainfield distribution unit is received. The drainfield distribution unit will be positioned below a grade of the drainfield. A sewage line can be connected to the inlet of the tank. The sewage line can be connected to a toilet or other drain within the building. The drainfield distribution unit can be either a multi-orifice pipe or a leaching chamber.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a diagrammatic illustration of a prior art gravity flow septic tank and gravity flow drainfield.

FIG. 2 a diagrammatic illustration of a gravity flow septic tank with a pump tank and a gravity flow drainfield.

FIG. 3 is a diagrammatic illustration of the gravity flow septic tank and drainfield of FIG. 1 showing the problems that can occur after a period of use.

FIG. 4 is a diagrammatic illustration of the septic tank or aerobic treatment tank level control system of one embodiment of the present invention.

FIG. 5 is a diagrammatic illustration of an alternative embodiment of the septic tank or aerobic treatment tank level control system of the present invention.

FIG. 6 is a perspective view of a simple embodiment of the pump, level switch and discharge pipe as used in the present invention.

FIG. 7 is a perspective view showing the pump in the present invention installed within the interior of a filter.

FIG. 8 is a perspective view of the pump of the present invention in which the pump and the filter are installed into the interior of a vault.

### DETAILED DESCRIPTION OF THE INVENTION

FIG. 4 shows the septic tank or aerobic treatment tank level control system 70 of the present invention. The level control system 70 has a building 72 having a commode 74 located on the interior thereof. The building 72 can have a wide variety of other types of drains in the interior thereof. These drains can be connected to a discharge pipe 76. Discharge pipe 76 is connected to the inlet 78 of tank 80. Tank 80 is a two compartment septic tank. The tank 80 can, within the concept of the present invention, be a single compartment septic tank, a multi-compartment septic tank, a multi-compartment aerobic treatment tank or similar structure. In particular, there is a first compartment 82 and a second compartment 84. A pipe 86 connects the first compartment 82 to the second compartment 84. The sewage passing through sewage outlet line 76 into inlet 78 will reside within the first compartment 82 and will have a level 88 therein. Once the sewage reaches level 88, it will flow through pipe 86 and into the second compartment 84. Typically, sludge will reside at the bottom of the first compartment 82 and the liquid will flow into the second compartment 84.

Importantly, the present invention places a pump 90 in the interior of the second compartment 84. Pump 90 is connected to a discharge line 92. Discharge line 92 extends upwardly from pump 90 so as to ultimately have an upper portion received by a bracket 94 located at the access riser 96 of the septic tank 80. Another portion of the discharge line 92 extends downwardly so as to connect with the outlet 98 of the tank 80. A check valve 100 and a level switch 102 are positioned within the second compartment 84. Check valve 100 will prevent the back flow of water through the discharge line 92 toward the pump 90. The level switch 102 is illustrated as a float switch and will generally have a portion residing at the level 104 of the liquid within the second compartment 84.

The discharge line 92 will be connected to the outlet 98 and to the transfer line 106. Transfer line 106 will be connected to the drainfield distribution unit 111. The drainfield distribution unit 111 can be either a multi-orifice pipe or a leaching chamber. The transfer line 106 can be in the nature of a solid pipe (without holes or orifices). The drainfield distribution unit 106 extends below grade 108 of drainfield 110. Drainfield distribution unit 106 has a plurality of openings 112 formed therein. These openings 112 will allow the liquid pass outwardly of the drainfield distribution unit 106 and into the drainfield 110.

In FIG. 4, it can be seen that the level 104 will be at the bottom of the vertical inner diameter of the outlet 98. When the level 104 is at this position, the pump 90 is deactivated so that no liquid will flow from the second compartment 84 into the transfer line 106. When the level of liquid 104 rises upwardly along the vertical distance between the top and bottom of the inner diameter of the outlet 98, the pump 90 will be activated so as to cause the liquid in the second compartment 84 to pass into the transfer line 106.

It is important in the present invention that the pump 90 continues to deliver a relatively small amount of liquid every time the pump 90 is activated. If the pump were activated so as to deliver a large volume of liquid, such as removing a substantial volume of the liquid from the second compartment 84. This would not be a desired result. As such, in the present invention, it is important to control the amount of liquid that is discharged into the drainfield distribution unit 111. Additionally, it is important to control the flow rate of the liquid through the discharge pipe 92 and into the transfer line 106. A flow orifice 114 is positioned on or within the discharge pipe 92 so as to limit the flow rate of liquid to the drainfield distribution unit 111. The flow orifice serves to control flow so that the quiescent zone of the septic tank or the clarifier of an aerobic system is not disturbed and so as to avoid pulling unnecessary solids into the filter or pump.

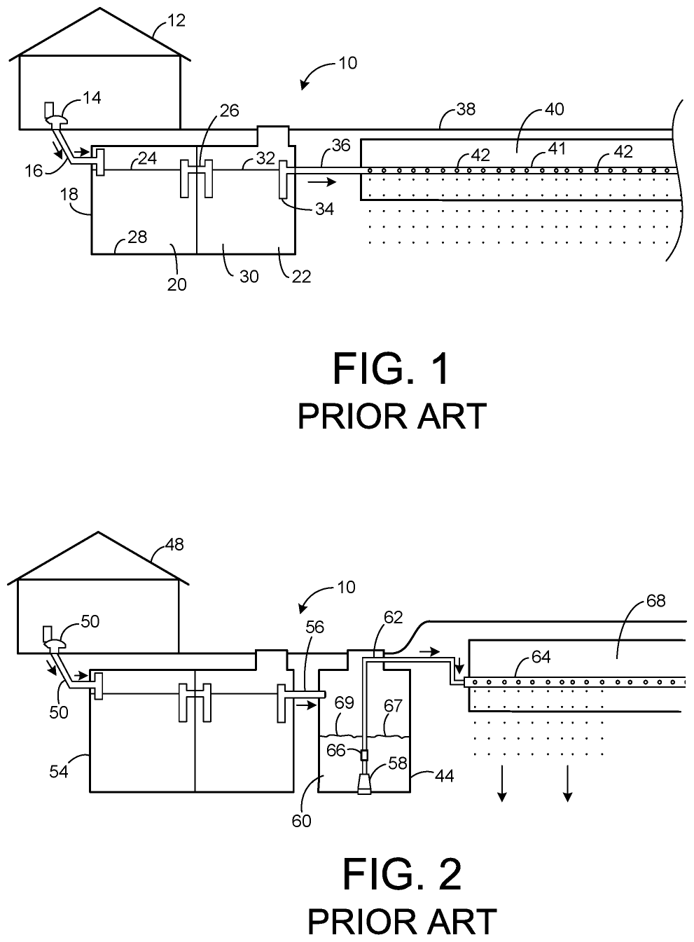

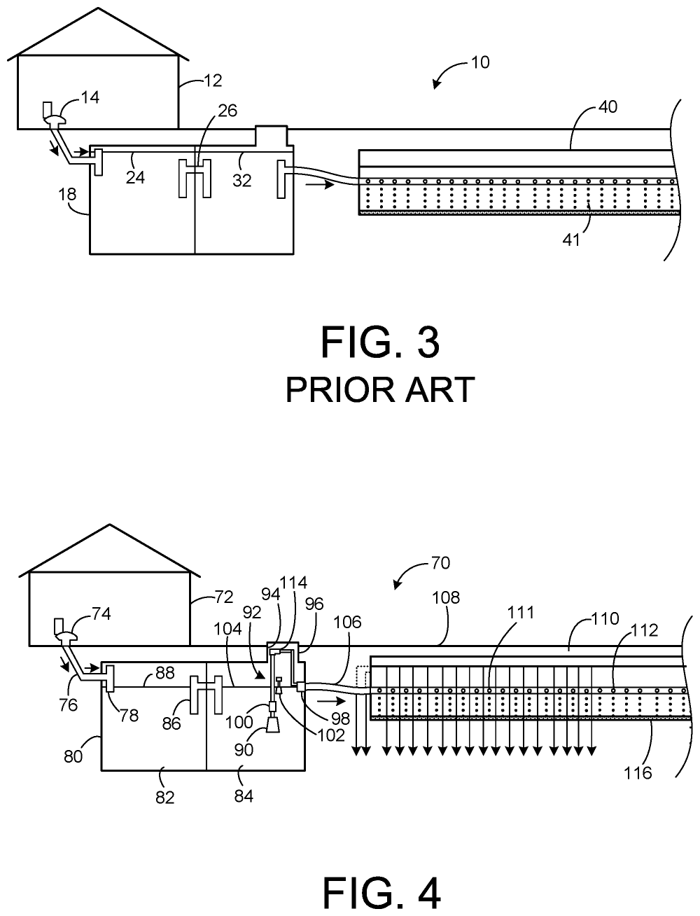

FIG. 4 shows that biomat 116 has developed through many years of use. The biomat 116 has formed on the soil interface and has plugged some of the soil. As shown in FIG. 3, this has caused a high level condition in the drainfield and consequently in the septic tank. In order to remedy this problem, the user of the system 70 will simply install the pump, the discharge pipe 92, and the level switch 102 into the septic tank 80. Until this installation occurs, the system 70 as shown in FIG. 4 is virtually identical to the system shown in FIGS. 1 and 3 of the prior art.

In order to install the septic tank level control device of the present invention, the lid on the access riser 96 is removed and the discharge pipe can be placed on the bracket 94. The discharge pipe 92 and the pump 90 will simply extend downwardly for a desired distance. Since the upper portion of the discharge pipe 92 is adjacent to the opening of the access riser 96, installation can be achieved in a quick and efficient manner Servicing can be easily performed because of the arrangement.

The septic tank or aerobic treatment tank level control device includes the pump 90, the bracket 94, the check valve 100, the level switch 102 and the flow orifice 114. It also includes the discharge pipe 92 which is connected to the outlet 98 of the septic tank 80. Upon installation, the septic tank level control device maintains a constant normal level in the septic tank 80 while discharging the effluent into the gravity-flow drainfield 110. As necessary, the level of the drainfield rises and the upper level of the drainfield receives the effluent so as to resume soil absorption or percolation. As such, the present invention solves the problem of not being able to flush commodes and the problems associated with slow drains. All of this is installed without the expense of excavating, purchasing and installing a pump tank and associated equipment, and damage to the landscaping.

Before the present invention, the only immediate level control options that a homeowner had was to install a pump tank (such as shown in FIG. 2) if there was enough room or to install a new drainfield if a suitable location could be found in the yard. Either option necessitated spending thousands of dollars and devastating the landscape. By way of the system 70, the problem can be solved by installing the equipment through the small opening at the access riser 96 of the existing septic tank lid. The cost is just a few hundred dollars. There is little to no damage to the environment or landscape.

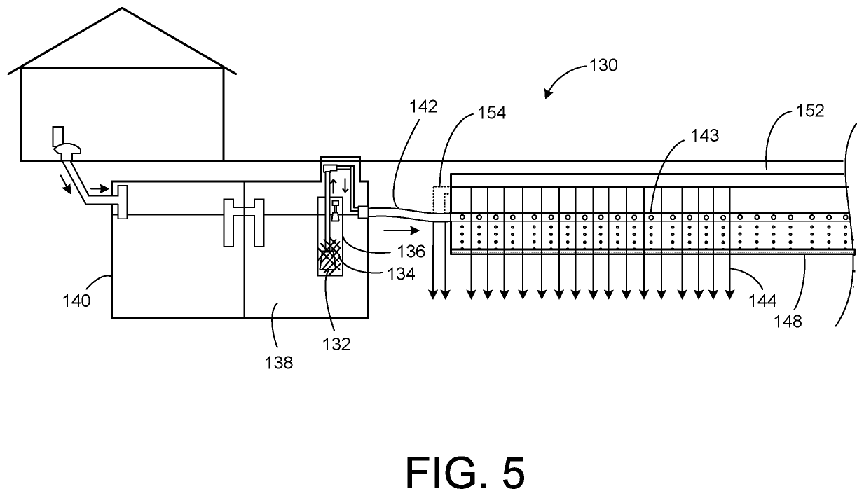

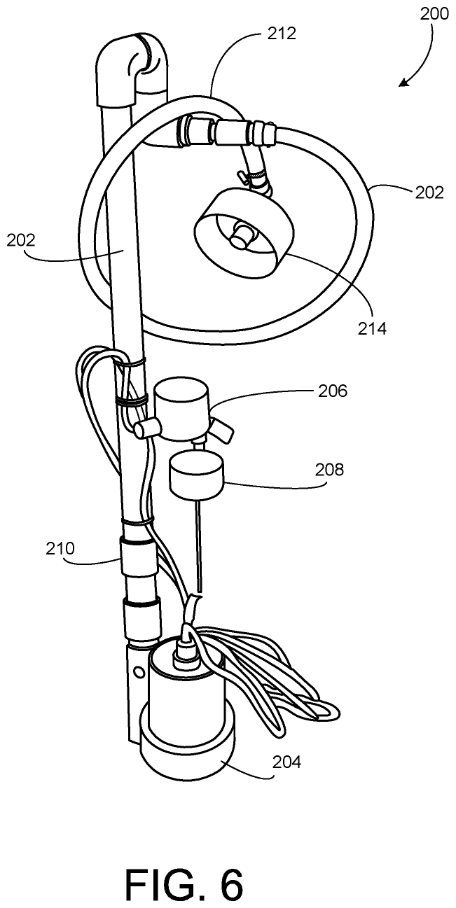

FIG. 5 shows a variation in the embodiment of FIG. 4. FIG. 5 shows a system 130. System 130 is extremely similar to the system 70 (a shown in FIG. 4). However, in FIG. 5, it can be seen that the pump 132 is received within a filter 134. Filter 134 is received within a vault 136. In this configuration, the inlet of the pump 132 will receive filtered liquid by virtue of filter 134. The vault 136 will assure the accurate positioning of the pump within the interior of the septic tank 140. It can be seen that the outlet of the septic tank 140 is connected to the transfer line 142. The transfer line will extend to the drainfield distribution unit 143. The drainfield distribution unit 143 can be a multi-orifice pipe or a leaching chamber. The transfer line 142 can be in the nature of solid pipe has a length suitable for extending to the drainfield from the septic tank 140. This arrangement is shown hereinafter in FIGS. 6-8.

In FIG. 5, it is important to note that the flow of liquid into the drainfield distribution unit 143 has several unique results. There is drainage in direction 144 down toward groundwater. The flow of liquid can cause the effluent to percolate upwardly. As such, more area or volume of the drainfield 152 can be used for receiving the effluent. A further benefit of the present invention is the sidewall percolation 154. In contrast, gravity-flow systems would assure that the effluent simply drains downwardly in the direction of lines 144. The upward percolation of the liquid allows for the sidewall percolation 154. This upward percolation would not occur in many unpressurized systems or gravity drainage systems. The sidewall percolation 154 occurs because the upward flow of effluent will ultimately emerge out of the sidewall of the drainfield 152. As such, the present invention greatly extends the life of the drainfield 152 by allowing the upper areas of the drainfield to be used. As such, the present invention can operate to extend the life of the drainfield 152 and will avoid backups in the septic tank.

FIG. 6 shows the septic tank level control device 200. This is installed through the opening and the access riser of the septic tank lid and usually through a grade level access riser or lid. The bracket is attached to the septic tank riser or lid. The discharge piping 202 rests on the bracket. Although the support bracket is the method of choice for suspending the septic tank level control device 200 into the septic tank, a variety of other devices, such as chains, ropes, wires, etc. could also be used to suspend the pump 204 within the septic tank. The discharge pipe 202 and/or the pump 204 could also be supported by the septic tank wall. Also, the pump 204 could be supported from the bottom floor of the septic tank.

The pump 204 is to be positioned in the septic tank between the upper scum level and the bottom sludge level. The final compartment of the septic tank is the preferred location. However, the pump 204 could work in any compartment or in a single compartment.

The level control switch 206 turns the pump 204 on and off in order to control the level in the septic tank within the normal operating range. Although the float 208 is the preferred embodiment of the level switch 206 of the present invention, a variety of devices, such as sensors, timers or a combination of devices could also be used. Once the level switch 206 turns the pump on, the clarified effluent is pulled into the inlet of the pump 204 and discharged through a check valve 210. This prevents backflow when the pump 204 is in the off position.

The effluent then travels through the discharge pipe 202 and through a flow orifice 212. The flow orifice 212 is designed to control the flow and, as a result, not disturb the quiescent clarified zone of the septic tank. This protects the pump 204 and the drainfield from unnecessary solids. Although a flow orifice is the preferred technique, various other devices could be used so as to control flow.

The discharge pipe 202 is connected by cap 214 to the outlet pipe of or within the septic tank. As such, it discharges effluent into the gravity flow drainfield through the outlet pipe and into the drainfield distribution unit.

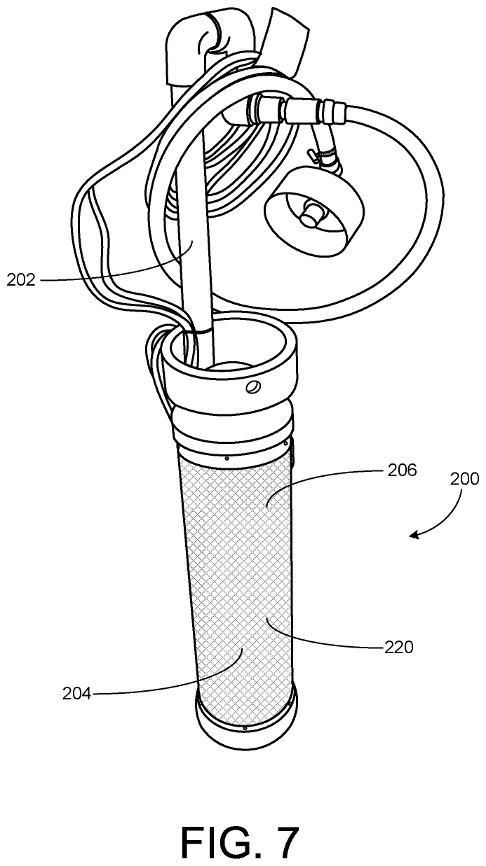

FIG. 7 shows a filter 220 that is positioned over the pump 204 of the septic tank level control device 200. Discharge pipe 202 extends from the pump 204 and outwardly of the filter 220. Filter 220 will serve to filter particles from entering the inlet of the pump 204. Filter 220 will also cover the level switch 206 and the float 208. As such, these items will not become clogged or interfered with by any debris that will remain in the clarified zone of the septic tank. As the pump 204 sucks in the liquid from the clarified zone through the filter 220, the filter 220 will remove small particles. The small particles can reside on the exterior of the filter 220. When it is desired to clean the filter 220, it is only necessary to lift the filter 220, along with the pump 204 and the level switch 206, from the septic tank by way of the access riser.

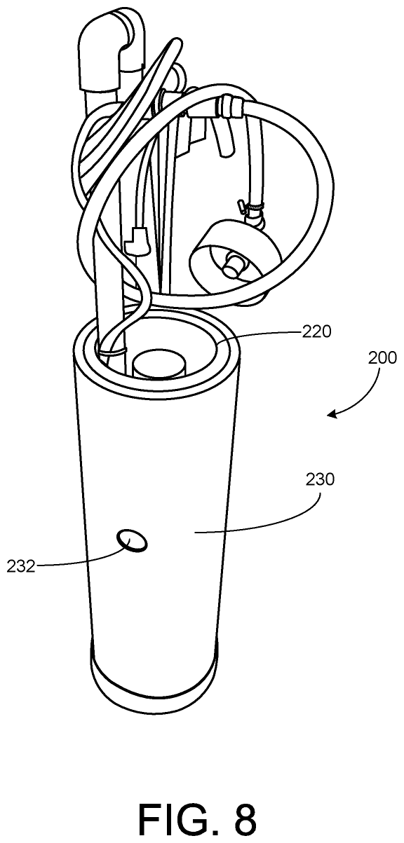

FIG. 8 shows the completed assembly of the septic tank level control device 200 of the present invention. In FIG. 8, a vault 230 receives the filter 220 on an interior thereof. As before, the pump 204 and the level switch 206 will also be received within the vault 230 and within the filter 220. Wall 230 has an opening 232. This serves as an intake hole so as to direct septic effluent from the clarified zone of the septic tank to the filter screen. These holes 232 can be located at varying depths along the outer portions of the vault 230 in order to maximize the septic tank clarified zone.

It should be noted that, in the present invention, there are several products on the market that convert septic tanks from an anaerobic environment to aerobic environment. The septic tank level control system of the present invention works equally well with septic tanks or aerobic treatment tanks. FIG. 8 shows the completed septic tank level control device ready to be installed into a septic tank. FIG. 8 shows not only the completed pump vault filter assembly but also shows the septic tank level control device within the pump vault filter assembly and ready to be installed into a septic tank.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

We claim:

1. A septic tank or aerobic treatment tank level control system comprising:
a tank adapted to be connected to a sewage outlet line of a building, said tank having an interior volume adapted to receive sewage from the sewage outlet line;
a transfer line connected to an outlet of said tank, said transfer line adapted to extend to a drainfield;
a drainfield distribution unit connected to said transfer line, said drainfield distribution unit adapted to discharge a liquid into the drainfield;
a pump positioned in said tank;
a discharge line connected to said pump and connected to the outlet of said tank, said discharge line adapted to pass the liquid under pressure from said pump through the outlet of said tank into said transfer line; and
a level switch operatively connected to said pump, said level switch activating said pump when the liquid in said tank reaches a first level and to deactivate said pump when the level of liquid in said tank reaches a second level, the first level being higher than the second level.

2. The septic tank or aerobic treatment tank level control system of claim 1, said tank being a septic tank, the septic tank having a first compartment and a second compartment.

3. The septic tank or aerobic treatment tank level control system of claim 2, the first compartment being connected by a pipe to the second compartment.

4. The septic tank or aerobic treatment tank level control system of claim 2, said pump being positioned in the second compartment, said discharge line extending to said pump within the second compartment, said level switch being positioned only in the second compartment.

5. The septic tank or aerobic treatment tank level control system of claim 1, said tank having an access riser and a lid at a top thereof, the access riser and the lid allowing access to an interior of the said tank, the septic tank or aerobic treatment tank level control system further comprising:
a bracket affixed to the access riser or the lid, said discharge line being received by said bracket.

6. The septic tank or aerobic treatment tank level control system of claim 1, further comprising:
a flow orifice affixed to or within said discharge line, said flow orifice adapted to restrict a flow rate of the liquid to the drainfield distribution unit.

7. The septic tank or aerobic treatment tank level control system of claim 1, said discharge line extending upwardly from said pump so as to have a portion adjacent a top of said tank, said discharge line extending downwardly from the portion to the outlet of said tank.

8. The septic tank or aerobic treatment tank level control system of claim 1, said discharge line having a check valve therein, the check valve preventing a flow of the liquid through said discharge line to said pump.

9. The septic tank or aerobic treatment tank level control system of claim 1, said level switch being a float switch having a portion adapted to float on the liquid in said tank, the float switch adapted to move between the first level and the second level of the liquid in the tank.

10. The septic tank or aerobic treatment tank level control system of claim 1, said pump having an inlet positioned in said tank, said pump having a filter extending over the inlet of said pump, the filter adapted to prevent particles above a desired size from entering the inlet.

11. The septic tank or aerobic treatment tank level control system of claim 10, said pump and the filter being received within an interior of a vault, the vault being positioned in said tank, said discharge line supporting said pump a desired distance above a bottom of said tank, the vault having at least one opening whereby the liquid in said tank flows therethrough and through the filter to the inlet of said pump.

12. The septic tank or aerobic treatment tank level control system of claim 1, the outlet of said tank being positioned at a distance above the bottom of said tank and an opposite side of said tank from the inlet of said tank.

13. The septic tank or aerobic treatment tank level control system of claim 12, the outlet of said tank being a vertical distance between a bottom of the inner diameter of the outlet and a top of the inner diameter of the outlet, the first level being along the vertical distance above the bottom of the inner diameter of the outlet, the second level being at the bottom of the inner diameter of the outlet.

14. The septic tank or aerobic treatment tank level control system of claim 1, further comprising:
a drainfield in which said drainfield distribution unit is received, said drainfield distribution unit being positioned below a grade of said drainfield.

15. The septic tank or aerobic treatment tank level control system of claim 1, said drainfield distribution unit being a leaching chamber or a multi-orifice pipe.

16. An apparatus for treating sewage within a tank having an access riser at a top thereof, the apparatus comprising:
a pump adapted to be positioned in the tank, said pump having an inlet adapted to receive a liquid from an interior of the tank;
a discharge line connected to an outlet of said pump and adapted to be connected to an outlet of the tank, said discharge line extending upwardly from said pump and adapted to be positioned adjacent to the access riser of the tank, said discharge line and said pump adapted to pass the liquid under pressure from said pump through the outlet of the tank; and
a level switch operatively connected to said pump, said level switch activating said pump when the liquid in the tank reaches a first level and deactivating said pump when the level of liquid in the tank reaches a second level, the first level being higher than the second level.

17. The apparatus of claim 16, further comprising:
a bracket adapted to be affixed to the access riser of the tank, said bracket receiving said discharge line therein so as to support said discharge line adjacent to the access riser.

18. The apparatus of claim 16, said pump having a filter extending over the inlet of said pump, the filter adapted to prevent particles above a desired size from entering the inlet of said pump.

19. The apparatus of claim 18, said pump and the filter being received within an interior of a vault, the vault adapted to be positioned in the tank, said discharge line supporting said pump a desired distance above a bottom of the tank, the vault having at least one opening whereby the liquid in the tank flows therethrough and through the filter to the inlet of said pump.

20. The apparatus of claim 16, further comprising:
a flow orifice affixed to or within said discharge line, said flow orifice adapted to restrict a flow rate of the liquid passing through said discharge line; and
a check valve positioned within said discharge line, said check valve adapted to prevent a flow of liquid through the discharge line to said pump.
